(19) United States
(12) Patent Application Publication
(10) Pub. No.: US 2008/0000207 A1
(43) Pub. Date: Jan. 3, 2008

(54) Crop-processing device comprising a picking-up and cutting device

(76) Inventors: Sjoerd Sieger De Vries, Hallum (NL); Cornelis Christianus Franciscus Havermans, Zevenbergen (NL)

Correspondence Address: HOWREY LLP, C/O IP DOCKETING DEPARTMENT, 2941 FAIRVIEW PARK DR., SUITE 200, FALLS CHURCH, VA, 22042, US

(21) Appl. No.: 11/812,594

(22) Filed: Jun. 20, 2007

(30) Foreign Application Priority Data
Jun. 22, 2006 (NL) 1032041
Dec. 20, 2006 (NL) 1033094
May 16, 2007 (NL) 1033854
May 24, 2007 (NL) 1033882

(51) Int. Cl. A01D 82/00

(52) U.S. Cl. 56/1

(57) ABSTRACT

A crop-processing device with a picking-up and cutting device for picking up and cutting an agricultural product. The crop-processing device furthermore has a discharge duct for discharging cut agricultural product from the crop-processing device, in which discharge duct first and second rotating accelerating elements are arranged for conveying the cut agricultural product through the discharge duct by contact with the cut agricultural product. The peripheral speed of the second accelerating element is greater than the peripheral speed of the first accelerating element. As a result, the acceleration up to the desired discharge speed, and thus the discharge of the product, is more uniform. Furthermore, the device requires less power than known crop-processing devices.

### CROSS REFERENCE TO RELATED APPLICATIONS

This application claims priority from Dutch application numbers 1032041 filed on 22 Jun. 2006, 1033094 filed on 20 Dec. 2006, 1033854 filed on 16 May 2007 and 1033882 filed on 24 May 2007, the contents of each of which are hereby incorporated by reference in their entirety.

### BACKGROUND OF THE INVENTION

1. Field of the Invention

The invention relates generally to a crop-processing device provided with a picking-up and cutting device for picking up and cutting an agricultural product and more particularly to such a device including a discharge device for discharging the cut agricultural product.

2. Description of the Related Art

Devices are known for picking up and discharging a cut product. One drawback of known devices relates to the efficiency with which the product can be cut and discharged. Harvesting machines in the form of forage harvesters are also known, having a picking-up and cutting device, a discharge duct and a rotating accelerating element for discharging cut agricultural product through the discharge duct. One such harvesting machine is described in EP-A1-1151654. Another similar device is known from DE-A1-3727165. Those devices however, require a compacting unit consisting of several pairs of rollers located opposite one another for compacting the picked-up agricultural product. The compacted product is fed to a cutting unit in the form of a cylinder chopper that acts against a blade. Such a combination of compacting unit and cylinder chopper performs the cutting operation accurately but has the drawbacks that it requires considerable power to operate the picking-up and cutting device and that the working width is also relatively limited.

Another form of agricultural vehicle is known from Dutch patent specification NL-C-1024652 in which a forage box is described, by means of which agricultural products are picked up, cut into pieces and kept in the forage box. The forage box is taken to a destination location where the agricultural products are delivered to be processed. The cutting arrangement comprises a rotor having a plurality of teeth or tines. The tines rotate to transport the crop past stationary knives that are resiliently mounted to avoid damage by hard objects. Although this agricultural vehicle functions well, it suffers from the general drawback that no agricultural products can be picked up and cut while the agricultural products are being taken to their destination.

Other devices are known in which the product is discharged via a discharge duct to a separate transport trailer. In order to discharge at a sufficient height, the cut product must gain a certain speed so that it can be transferred to the transport trailer or the like in an evenly distributed manner. A device of this type is known from DE-A1-3820703 that also uses a cutter arrangement of rotating tines with fixed blades. Another device is known from DE 202004018359 U1 in which either a transport belt or a blower may be used to raise the cut product. Blowers having a discharge duct generally have the advantage of being more easy to orientate than transport belts. In general, the efficiency of discharge of known blowers is relatively low and it is often the case that a large amount of power is required in order to ensure that the discharge keeps up with the picking-up and cutting operation. In many cases, vehicles with a power of several hundreds of kilowatts are required, thus resulting in high fuel consumption. In addition, such vehicles are often heavy and can thus not be used on any desired terrain and under all weather conditions.

There is thus a particular need for a crop-processing device that may be operated to both cut and discharge crop in a more efficient manner. In this case, the processing device may require less supplied power for the same processing capacity. Alternatively, using an engine having the same power, it may be possible to process more crop per unit time.

### BRIEF SUMMARY OF THE INVENTION

The present invention addresses these problems by providing a crop-processing device provided with a picking-up and cutting device for picking up and cutting an agricultural product, as well as with a discharge device for discharging the picked-up and cut agricultural product. The picking-up and cutting device is provided with a pick-up unit for picking up the agricultural product and with a cutting unit for cutting the picked-up agricultural product The discharge device comprises a discharge duct for discharging the cut agricultural product in a discharge direction, with a first rotating accelerating element and a second rotating accelerating element, placed behind the first accelerating element viewed in the discharge direction, in the discharge duct, for conveying the cut agricultural product through the discharge duct by means of contact with the cut agricultural product. According to the invention, a peripheral speed of the second accelerating element is greater than a peripheral speed of the first accelerating element. In this context, peripheral speed is understood to refer to the velocity at an outer circumference of the accelerating element. The crop-processing device provided in this manner may operate with relatively high efficiency, probably because the discharge is carried out in stages. As a result thereof, the accelerating element does not have to accelerate the crop in one go from the normal cutting speed, usually hardly faster than the driving speed of a few meters per second, to the desired ejection speed, which, may be as much as approximately 50 meters per second.

In one embodiment, the peripheral speed of the first accelerating element is between 5 and 25 m/s. Such a peripheral speed for the first accelerating element may provide an advantageous first stage, in which, for example, the grip on the product is good, so that few blockages occur and the discharge takes place in a uniform fashion.

In a preferred embodiment, the peripheral speed of the second accelerating element is between 10 and 50 m/s. This value for the peripheral speed can take the crop to be supplied to the second accelerating element to a desired ejection speed in an efficient manner. This applies in particular for a device in which the first accelerating element has a peripheral speed which is in the range indicated above.

In particular, the diameter of the first accelerating element is at least 400 mm, preferably at least 450 mm. With these minimum dimensions for the first (accelerating) element, an excellent discharge may be achieved. Particularly the risk of the crop being wound around the accelerating element in an undesirable manner may be thereby limited. On the other hand, it is advantageous not to make the first accelerating element too large. It is preferable to adhere to a maximum diameter of around 600 mm and advantageously of approximately 550 mm. With such values, the periphery of the first accelerating element may be sufficiently similar to the periphery, or discharge, of the cutting unit, so that an efficient discharge is ensured.

Advantageously, the diameter of the second accelerating element is between 400 and 800 mm, preferably between 450 and 700 mm. Such values are favorable as regards efficiency. In general, the second accelerating element can have a slightly larger diameter than the first, since the transfer of the crop by the second accelerating element is simpler due to the higher crop speed downstream of the first accelerating element compared to the speed at which the crop is presented by the cutting unit.

In particular, the first and the second accelerating element are rotatable about respective parallel shafts. This greatly facilitates the transfer of the crop from the first to the second accelerating element. However, it is also possible for the second accelerating element to rotate about a shaft having a different orientation.

The respective shafts are preferably at right angles to an intended advancement direction of the crop-processing device. As the picking-up and cutting unit usually has a body rotating about a similar shaft, further processing is simple if the elements which follow do the same. However, it is also possible that at least the second accelerating element can rotate about a shaft which is parallel to the advancement direction. This could be particularly advantageous if the processed crop is ejected to the side, although a completely parallel configuration may also offer other advantages in such a case.

In one embodiment, the discharge duct is narrower at the position of the second accelerating element than at the first accelerating element. Advantageously, the accelerating elements are correspondingly narrower. It is considered advantageous with regard to the discharge efficiency not only to increase the (peripheral) speed, but also to reduce the diameter of the discharge duct.

In particular, at least the first and the second accelerating element each comprise a cylindrical body with projections. Such an embodiment provides a good grip on the pieces of the crop. However, it is also possible, for example, to use a cylinder made of a material which has a large amount of friction, such as rubber rollers.

Advantageously, the projections are at least 2 cm, preferably at least 5 cm long, that is to say the projections protrude at least 2, respectively at least 5 cm, above their immediate surroundings. It is also possible for their surroundings to be recessed by at least 2 or 5 cm, respectively. At such a minimum height, the grip is such that crop may become slightly lodged between the projections, which not only results in improved grip, but also leads to a form of buffer action. In the process, a slight accumulation of crop may occur due to it creeping up the projections and piling up. In a preferred case, the projections could comprise a front facing in the respective direction of rotation, a section of which, which is at least 2 cm long viewed from one end, is at an angle to a normal on the accelerating element of at most 45°. This results in good grip and good “creep behaviour”. It should be noted that the dimensions given above for the diameter of the accelerating element relate to the total diameter, i.e. including the height of any projections. It is believed to be of less consequence whether an accelerating element having a total diameter of 450 mm is made up of, for example, a roller with a diameter of 400 mm and projections of 25 mm, or a roller of 250 mm and projections of 100 mm.

In a particular configuration, the projections of the second accelerating element may have a larger mean width than the mean width of the projections of the first accelerating element. This measure is believed to have a favorable impact on the efficiency. It is assumed that the larger width results in a stronger air current, which is advantageous for transfer and further acceleration/conveying, which has just been achieved downstream of the first accelerating element. However, this measure is not compulsory, and a second accelerating element which is at least substantially identical to the first is also advantageous, in particular at different peripheral speeds.

In one embodiment, the width of the projections of the first accelerating element may be between 2 and 30 mm. Furthermore, the width of the projections of the second accelerating element may advantageously be between 100 and 400 mm, preferably between 250 and 300 mm. It is believed that such widths can make the device very efficient. At such widths, the projections of the first accelerating element can be referred to as teeth or fingers, and those of the second accelerating element as vanes, which also ensure a more constant discharge. Here, the width should in each case be measured parallel to the axis of rotation of the respective accelerating element. In this case, the “depth” of the projections, i.e. the dimension perpendicular to the axis of rotation and to the length, can be greater than the width, for example in order to impart strength to the projections.

In a particular embodiment, neighboring projections are arranged on the first accelerating element, staggered in the peripheral direction, advantageously in at least one spiral. This is believed to be favorable for a uniform discharge, with a reduced risk of impact loads. Advantageously, there are several spirals, or there is a single spiral comprising at least five windings wound around the accelerating element.

Advantageously, at least 80 projections per meter are arranged over the width of the first accelerating element, advantageously at least 80 projections per meter width for each spiral. These numbers were found to result in a satisfactory uniform discharge. In practice, at least 100, preferably at least 100 projections per meter per spiral, is highly advantageous. All this depends on the width of the projections as with narrower projections a higher density is possible.

In particular, the device according to the invention comprises an engine with a maximum engine power of less than 150 kW, more particularly less than 125 kW. Such an engine is sufficient for the device according to the invention, even at normal processing widths of, for example, 1.5 metres, at a speed of up to preferably 8 to 10 km/h. Of course, the device may also be provided without an engine, in which case the device is then designed to be coupled to a tractor vehicle, preferably having a similar maximum engine power. In addition, it is of course also possible to provide the device with a more powerful engine, such as for example of more than 200 kW, and/or to couple it to a tractor device having such a more powerful engine. This may be advantageous, for example, if such a vehicle is already available, or in order to increase the crop-processing capacity, preferably up to processing widths of 2 m and speeds of over 10 km/h. It is nevertheless a great advantage that much less engine power is now required for a common or average capacity. Obviously, this also has a positive effect on the costs of the entire device, and on fuel consumption, etc.

In an advantageous embodiment, an angle of contact between the cut agricultural product and the first accelerating element is between 45 and 100°, preferably between 60 and 90°. This angle is the angle at which the crop is accelerated within the device by the first accelerating element. The selected angles are advantageous for their accelerating effect, without too much risk of the crop winding itself around the accelerating element in an undesirable manner.

In an advantageous embodiment, an angle of contact between the cut agricultural product and the second accelerating element is between 5 and 45°, preferably between 5 and 30°. The angles given above for the second accelerating element are based on similar considerations as those for the angle for the first accelerating element. These are generally smaller, as it is assumed that it is sufficient in this case to give the crop only an accelerating “nudge”, without requiring a long path. Furthermore, the air current generated by the second accelerating element can improve the effectiveness of a small angle of contact. In particular, the contact between the cut agricultural product and the second accelerating element is substantially tangential.

In another advantageous embodiment, the angles of contact between the cut agricultural product and the first accelerating element and the second accelerating element are substantially equal, i.e. they differ by at most 10°. For example, product is supplied at an angle of approximately 30° to the horizontal plane. The angles of contact between the cut agricultural product and the first and second accelerating element, respectively, are in that case preferably both approximately 30°. Tests have shown that a very uniform product flow is also possible with this configuration.

The cutting device advantageously comprises at least one fixed knife and at least one movable knife which is movable with respect to and is in contact with the at least one fixed knife. In all practical cases, the movable knife will be a rotating knife although other movements including reciprocation may be considered. Preferably, the fixed knife comprises several fixed knives which are arranged parallel to one another, and the movable knife comprises several rotating knives which are connected to one another and arranged parallel to one another, which can at least partly move between the fixed knives. In this case, the crop is neatly cut into pieces, for example into pieces having a length of a few centimeters. The cutting device is in particular not a cylinder chopper. This cutting device, as well as the pick-up device and the conveying device (accelerating elements and the like) are all designed for processing an intended crop, such as grass or hay. To this end, the pick-up device for example comprises a toothed roller, etc.

Advantageously, the picking-up and cutting device is only provided with the pick-up unit and the cutting unit. In particular this means that the device does not comprise a compacting device arranged between the pick up device and the cutting unit. Such a compacting device generally used with a cutting drum usually requires a large amount of power.

The agricultural product may be of a general nature. In particular, the agricultural product comprises elongate stalks, more particularly grass or hay. Alternatively, it is also possible to choose crops such as maize.

In one advantageous embodiment, a collecting container is provided between the cutting device and the discharge device for collecting the cut agricultural product, which collecting container is provided with means for conveying the cut agricultural product to the discharge device. Such a collecting container or buffer store is advantageous in order to achieve a uniform trouble-free discharge of product. The volume of the collecting container may be limited in size to provide merely sufficient capacity for a change over between transport trailers or the like.

In a further advantageous embodiment, the discharge duct is curved, and at least the surface of the internal walls of at least the curved parts of the discharge duct has a low coefficient of friction in order to assist conveyance of the cut agricultural product through the discharge duct. This may, for example, be achieved by coating the internal walls with a material having a low coefficient of friction, such as Teflon® or other materials which are known per se, including certain kinds of plastic, or by manufacturing the walls of the discharge duct from such materials.

In another embodiment, the discharge duct comprises an angle-adjustment arrangement for adjusting the discharge angle of the product. The angle-adjustment may in this case comprise an arrangement for adjusting a horizontal and/or a vertical angle. Thus, it is possible, for example, to adjust the distance over which the product is ejected and/or the position where it lands.

In a particular embodiment, the device comprises a collecting tray, which is designed for collecting product delivered out of the discharge duct. As the device according to the invention is able to provide a very uniform product discharge, it will be possible to load the collecting tray in a very uniform manner as well. In particular when the angle-adjustment arrangement is used as well, the collecting tray can also be filled completely. Advantageously, the tray is detachable, for example replaceable or exchangeable.

Most advantageously, the device comprises a product-compressing device designed for compressing the product that is in the collecting tray. In this manner, the amount of product that is collected in the collecting tray can be increased, without the collecting tray having to be made too high (total height of device for example less than 4 metres) or otherwise too large. In addition, the product does not have to be compressed by the picking-up and cutting unit, so that the latter not only requires less power, but also the cutting quality is higher and more consistent. The cutting rotor or the like may, for example, be of a lighter design.

The product-compressing device may, for example and advantageously, comprise a displaceable wall, advantageously a hydraulic roof and/or a hydraulic side wall of the collecting tray. This side wall or the roof, respectively, can be moved sideways or downwards, respectively, by hydraulic means while simultaneously compressing the product. If desired, this can be carried out several times while the collecting tray is being filled. A further advantage of providing a displaceable side wall is the fact that it can also push the contents out of the collecting tray in order to unload the latter. Advantageously, an opposite wall is in this case designed to be displaceable, such as liftable or tiltable.

According to a yet further advantage, the device comprises a first housing surrounding the discharge device, preferably in addition to a second housing joined to the first housing and surrounding the picking-up and cutting device. Preferably, the first housing is closed as far as possible. Thus, as little as possible fresh air is sucked in and the risk of undesirable ejection of product is reduced.

In another advantageous embodiment, the second housing comprises a movable protective plate at the rear, viewed in the intended direction of travel. By, for example, hydraulically moving this plate, in particular away from the picking-up and cutting device, any blockages can be removed in a simple manner. When the device is in use, the protective plate is in position in order to protect the driver, etc.

The present invention furthermore relates to an agricultural vehicle provided with a picking-up and cutting device for picking up and cutting an agricultural product in which the picking-up and cutting device is only provided with a pick-up unit for picking up the agricultural product and a cutting unit for cutting the picked-up agricultural product and in which the cutting unit further comprises a conveyor for conveying the agricultural product through a conveying duct having an outlet for delivering the cut agricultural product and wherein the agricultural vehicle is furthermore provided with a discharge duct for discharging cut agricultural product from the outlet from the agricultural vehicle. The discharge duct comprises a rotating accelerating element arranged for conveying the cut agricultural product through the discharge duct by means of contact with the cut agricultural product. By use of the discharge duct and the rotating accelerating element, it is possible to transfer agricultural product present in the agricultural vehicle during operation of the agricultural vehicle to a vehicle driving, for example, next to the agricultural vehicle and having a container for agricultural product. When this container is full or virtually full, it can be replaced by another vehicle with an empty container without interrupting the operation of the agricultural vehicle for picking up and cutting the agricultural product. Preferably, the cutting unit contains knives which are movable between a cutting position in which they extend into the conveying duct, in such a manner that the agricultural product is cut into pieces, and a deflected position in which they substantially retract from the conveying duct, with the knives being pushed into the cutting position by means of a spring.

Using relatively little engine power (150-200 hp), the agricultural vehicle according to the invention can achieve a working width which is approximately 1.5 to 2 times larger than with the known harvesting machines and yet is able to discharge (i.e. eject) the cut agricultural product from the agricultural vehicle in a reliable manner.

In one embodiment of an agricultural vehicle according to the invention, a collecting container is provided between the outlet of the conveying duct and the discharge duct for collecting the cut agricultural product, which collecting container is provided with a conveyor for conveying the cut agricultural product to the rotating accelerating element. In this manner, a certain buffer stock can be stored in the agricultural vehicle itself, so that it is not always necessary for an additional vehicle with a container to be next to the agricultural vehicle in order to collect cut agricultural product. The conveyor for conveying agricultural product to the accelerating element may consist of devices which are known per se, such as augers, conveyor belts and the like.

In order to be able to discharge cut agricultural product correctly for each kind of agricultural product, one embodiment of the agricultural vehicle according to the invention has two rotating accelerating elements arranged one after the other in the discharge duct for conveying the cut agricultural product through the discharge duct by means of contact with the cut agricultural product.

### BRIEF DESCRIPTION OF THE DRAWINGS

The features and advantages of an exemplary embodiment of a crop-processing device according to the invention will be described below by way of example with reference to the drawing, in which:

FIG. 1 shows a diagrammatic side view in partial cross section of a device according to the invention,

FIG. 2 shows a partially cut-away front view of the device according to FIG. 1, and

FIG. 3 shows a diagrammatic side view of another device according to the invention.

### DESCRIPTION OF ILLUSTRATIVE EMBODIMENTS

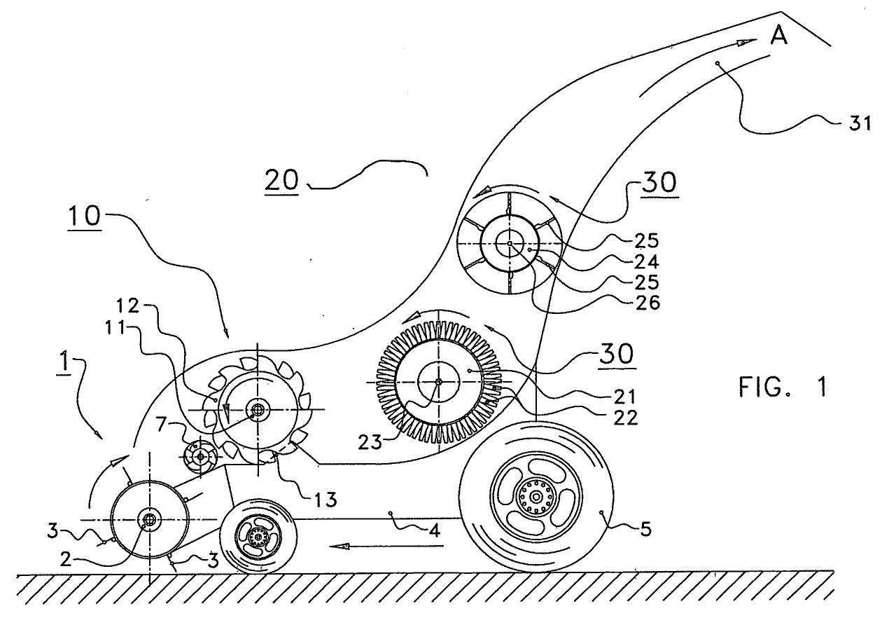

FIG. 1 shows a diagrammatic side view in partial cross section of a device according to the invention. The device comprises a pick-up device 1 on a frame 4 with wheels 5, a cutting device 10 and a discharge device which is denoted overall by reference numeral 20.

The pick-up device comprises a rotating body 2 having teeth 3. The cutting device 10 comprises a rotating body 11 having several teeth or carriers 12, as well as one or more fixed knives 13.

The discharge device 20 comprises a first accelerating element 21 with projections 22, which rotates about a first shaft 23, as well as a second accelerating element 24 with projections 25, which rotates about a second shaft 26. Furthermore, a discharge duct 30 with an outlet opening 31 is provided.

The various rotating components rotate in the directions as indicated by the respective arrows, with the product to be discharged being discharged in the direction of arrow A. Obviously, it is also possible to reverse the direction of rotation, but in this case the discharge direction A remains unchanged.

In operation, the pick-up device 1 picks up the crop to be processed, such as cut stalks or hay, from the ground. This product is fed to the cutting device 10 which is also known per se. There, the product is carried along by the rotating teeth or carriers 12, of which at least the ends can move between fixed knives 13, where the product is cut due to the interaction between the teeth or carriers 12 and the knives 13. Advantageously, at least some of the teeth or carriers 12 and/or knives 13 are resiliently mounted.

Subsequently, the cut product is fed to and gripped by the projections 22 of the first accelerating element 21. The speed of the product at the cutting device 10 is virtually equal to the peripheral speed of the teeth or carriers 12, and this is usually approximately equal to the speed of travel, generally around 5 m/s. The peripheral speed of the first accelerating element 21 is, for example 8 or 10 m/s. The projections 22 are in this case shown as some kind of teeth, made of for example plastic, arranged in one or a few spirals with a total outer diameter of, for example, 500 mm, and with a density of 100 teeth per meter. The dimensions of the teeth are, for example, 15 cm high (in the direction perpendicular to the first shaft 23), 5 mm wide (measured in the direction parallel to the first shaft 23) and narrowing to the top to a “depth” of 4 cm.

The product which has been accelerated in this way is fed to and gripped by the second accelerating element 24. This has projections 25 in the form of vanes with a total outer diameter of, for example, 600 mm, which accelerate the product by means of an additional “nudge” until it approximately reaches the peripheral speed of accelerating element 24, in this case for example 25m/s. The product is then discharged through discharge duct 30, in the direction of outlet opening 31, via which it can be loaded onto, for example, a lorry or trailer.

A buffer store between the cutting device 10 and the discharge device 20 is not shown. This buffer store may comprise a buffer space in which cut product from the cutting device 10 ends up, as well as feeding means, such as an auger or conveyor belt, for feeding the product to the discharge device 20. These feeding means can be, for example, controlled and can, in particular, be temporarily switched off, as a result of which discharge from the opening 31 can reliably be stopped temporarily, for example when another lorry has to be driven under the opening 31.

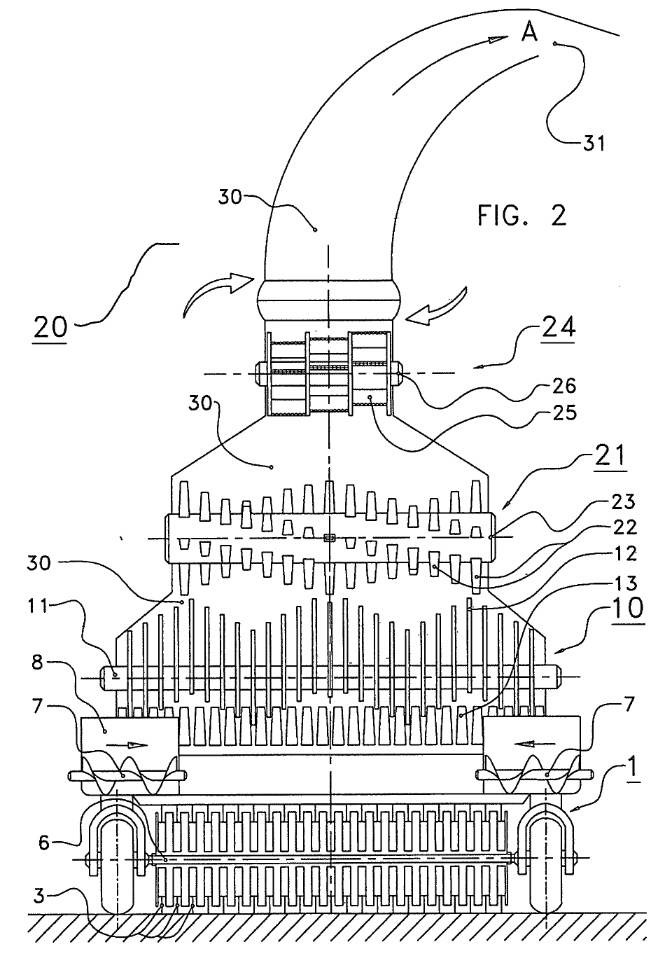

FIG. 2 shows a partially cut-away front view of the device according to FIG. 1. It is note that this drawing is not to scale and is also merely diagrammatic. Identical components are denoted by the same reference numerals as in FIG. 1.

The pick-up device 1 comprises teeth 3 which pass through holes 6. The supply of picked-up product to the cutting device 10 is narrowed by means of lateral augers 7 and guide panels 8.

The cutting device comprises a series of parallel fixed (counter) knives 13, as well as a roller 11, likewise having a series of parallel tines 12, which can move between knives 13. Incidentally, in this context, the expression “fixed” should be interpreted as having a fixed rest position. The knives 13 can indeed be resiliently mounted e.g. in order to reduce damage by stones or other hard objects.

Downstream of the cutting device 10, the cut product is fed to discharge duct 30, which in this particular case is narrower than the width of the cutting device 10. Inside the discharge duct 30, the first accelerating element 21 is arranged with a body or first shaft 23 having projections 22, which grip and accelerate the product, and subsequently discharge it in the direction of the second accelerating element 24, which also has a body or second shaft 26 having vanes 25. The second accelerating element 24 then transports the product away via the duct 30 and the outlet opening 31 to the outside. As described above, the speed of the product has increased in a stepwise manner. The width of the discharge duct 30 has decreased in stages, which is advantageous, but not compulsory.

None of the figures show the drive mechanism of the various rotating components, but it is believed that the person skilled in the art will readily be aware of how to complete such details. In addition, in many cases details which are known per se and possibly advantageous have not been shown, such as an adjustable discharge duct.

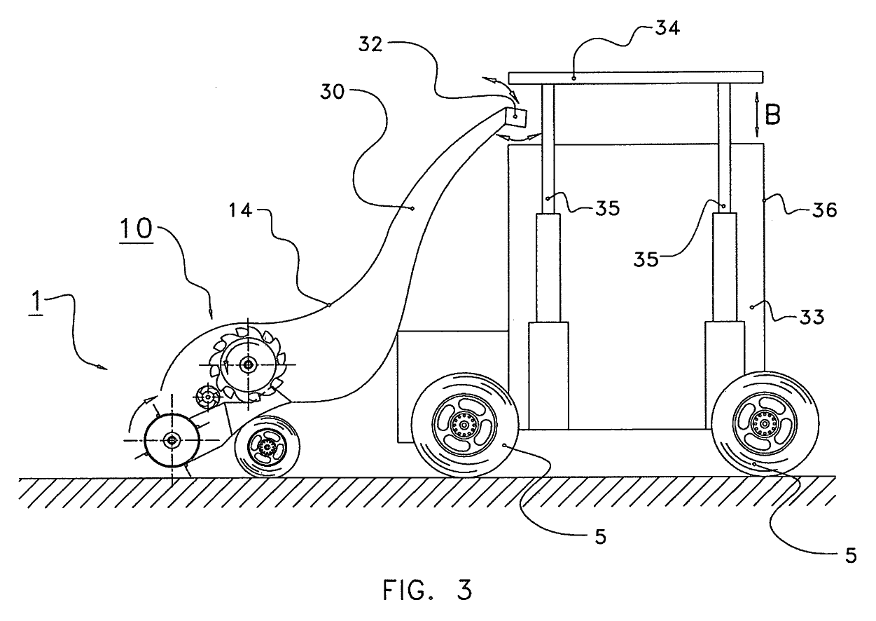

FIG. 3 shows a diagrammatic side view of another device according to the invention. In this case, 1 and 10 denote a pick-up and cutting unit, respectively, which are not shown in further detail. A discharge duct 30 is provided with an angle-adjusting means 32, which can be moved in the directions of the arrows. Furthermore, reference numeral 33 denotes a collecting tray with a roof 34 which can be moved by means of hydraulic cylinders 35.

Using the angle-adjusting means 32, for example a plate or tube which can be moved by a motor, a product stream can be directed from the discharge opening to the collecting tray 33. As a result, the collecting tray can be filled in an optimum manner, both with regard to the product properties, such as a very even filling, and the absolute load, since any angle can be used. In addition, in order to be able to further increase the maximum total load, a hydraulic roof 34 with cylinders 35 is provided. By retracting the cylinders in the direction of arrow B, the roof can compress the product. Of course, it is advantageous in this case that the device can be filled very homogeneously with the aid of means 32, so that the properties of the product remain homogeneous, even after compression, and the hydraulic roof is not locally subjected to excessive loads.

Alternatively or in addition, it is also possible to design one or more side walls 36 so that they can be moved hydraulically. The product can also be compressed in this way. In addition, if one side wall pushes and an opposite side is removable, liftable or the like, the product can be pushed out of the collecting tray 33 in a simple manner.

Furthermore, it can be seen that a housing 14 is provided surrounding the pick-up device 1 and the cutting device 10, which housing continues around the discharge device (not shown separately here). For the sake of simplicity, the housing 14 in this case is a single uninterrupted housing. In practice, one or more flaps, covers and the like will be provided, for example for maintenance and the like. In that case, it is also advisable to ensure that such components of the housing 14 fit together as tightly as possible, as fresh air might be sucked in through gaps and cause ejection of product. The same applies in the case of several partial housings which must fit together tightly to avoid gaps.

A protective covering panel (not shown) is provided on the rear of the pick-up device 1 and/or the cutting device 10, which can for example be folded down hydraulically, in order to clear blockages or the like.

The illustrated embodiments are not intended to be limiting in any way and solely described by way of example. It will be recognized that these embodiments are susceptible to various modifications and alternative forms well known to those of skill in the art without departing from the spirit and scope of the invention as determined by the appended claims.

What is claimed is:

1. A crop-processing device comprising:
a pick-up unit for picking up an agricultural product;
a cutting unit for cutting the picked-up agricultural product; and
a discharge device for discharging the picked-up and cut agricultural product, the discharge device comprising:
a discharge duct for discharging the cut agricultural product in a discharge direction and first and second rotating accelerating elements placed in the discharge duct for conveying the cut agricultural product through the discharge duct by means of contact with the cut agricultural product, the second rotating accelerating element being located behind the first accelerating element viewed in a discharge direction and being operable to rotate with a peripheral speed that is greater than a peripheral speed of the first accelerating element.

2. Crop-processing device according to claim 1, in which the peripheral speed of the first accelerating element is between 5 and 25 m/s.

3. Crop-processing device according to claim 2, in which the peripheral speed of the second accelerating element is between 10 and 50 m/s.

4. Crop-processing device according to claim 1, in which the diameter of the first accelerating element is at least 400 mm.

5. Crop-processing device according claim 4, in which the diameter of the second accelerating element is between 400 and 800 mm.

6. Crop-processing device according to claim 1, in which the first and the second accelerating elements are rotatable about respective parallel shafts.

7. Crop-processing device according to claim 6, in which the respective shafts are at right angles to an intended advancement direction of the crop-processing device.

8. Crop-processing device according to claim 1, in which the discharge duct is narrower at a position of the second accelerating element than at a position of the first accelerating element.

9. Crop-processing device according to claim 1, in which the first and the second accelerating elements each comprise a cylindrical body having projections.

10. Crop-processing device according to claim 9, in which the projections are at least 2 cm long.

11. Crop-processing device according to claim 9, in which the projections of the second accelerating element have a larger mean width than a mean width of the projections of the first accelerating element.

12. Crop-processing device according to claim 9, in which a width of the projections of the first accelerating element is between 2 and 30 mm.

13. Crop-processing device according to claims 12, in which a width of the projections of the second accelerating element is between 100 and 400 mm.

14. Crop-processing device according to claim 9, in which neighboring projections are arranged on the first accelerating element to be staggered with respect to one another in a peripheral direction.

15. Crop-processing device according to claim 14, in which at least 80 projections per meter are arranged over the width of the first accelerating element.

16. Crop-processing device according to claim 1, comprising an engine with a maximum engine power of less than 150 kW.

17. Crop-processing device according to claim 1, in which an angle of contact between the cut agricultural product and the first accelerating element is between 45 and 100°.

18. Crop-processing device according to claim 1, in which an angle of contact between the cut agricultural product and the second accelerating element is between 5 and 45°.

19. Crop-processing device according to claim 17, in which contact between the cut agricultural product and the second accelerating element is substantially tangential.

20. Crop-processing device according to claim 1, in which an angle of contact between the cut agricultural product and the first accelerating element, and an angle of contact between the cut agricultural product and the second accelerating element are substantially equal and measure approximately 30°.

21. Crop-processing device according to claim 1, in which the cutting unit comprises at least one fixed knife and at least one rotating tooth or carrier which is movable with respect to the at least one fixed knife.

22. Crop-processing device according to claim 21, in which the pick-up unit provides substantially uncompressed product to the cutting unit.

23. Crop-processing device according to claim 1, in which the agricultural product comprises elongate stalks of grass or hay.

24. Crop-processing device according to claim 1, in which a collecting container is provided between the cutting unit and the discharge device for collecting the cut agricultural product, the collecting container being provided with a conveyor element for conveying the cut agricultural product to the discharge device.

25. Crop-processing device according to claim 1, in which the discharge duct comprises a curved section and at least a surface of an internal wall of at least the curved section of the discharge duct has a low coefficient of friction in order to assist conveyance of the cut agricultural product through the discharge duct.

26. Crop-processing device according to claim 1, in which the discharge duct comprises an angle-adjustment arrangement for adjusting a discharge angle of the product.

27. Crop-processing device according to claim 1, further comprising a collecting tray arranged to collect product delivered from; the discharge duct.

28. Crop-processing device according to claim 27, further comprising a product-compressing arrangement, arranged to compress the product in the collecting tray.

29. Crop-processing device according to claim 28, in which the product-compressing arrangement comprises a displaceable wall of the collecting tray.

30. Agricultural vehicle provided with a picking-up and cutting device for picking up and cutting an agricultural product, wherein the picking-up and cutting device comprises a pick-up unit for picking up the agricultural product and a cutting unit for cutting the picked-up and substantially uncompacted agricultural product, the cutting unit comprising a conveyor for conveying the agricultural product through a conveying duct having a conveyor outlet, the agricultural vehicle further comprising a discharge duct for discharging from the agricultural vehicle the cut agricultural product originating from the conveyor outlet, a rotating accelerating element being arranged in the discharge duct for conveying the cut agricultural product through the discharge duct by contact with the cut agricultural product.

31. Agricultural vehicle according to claim 30, wherein a collecting container is provided between the conveyor outlet and the discharge duct for collecting the cut agricultural product, the collecting container comprising a conveyor for conveying the cut agricultural product to the rotating accelerating element.

32. Agricultural vehicle according to claim 30, wherein two rotating accelerating elements are arranged after one another in the discharge duct for conveying the cut agricultural product through the discharge duct by means of contact with the cut agricultural product.

33. Agricultural vehicle according to claim 30, wherein the discharge duct is curved and at least a surface of an internal wall of at least a curved part of the discharge duct has a low coefficient of friction in order to assist conveyance of the cut agricultural product through the discharge duct.
